(19) United States
(12) Patent Application Publication
(10) Pub. No.: US 2015/0131887 A1
(43) Pub. Date: May 14, 2015

(54) SYSTEM AND METHOD TO VISUALIZE AND ANALYZE DATA FROM IMAGE-BASED CELLULAR ASSAYS OR HIGH CONTENT SCREENING

(71) Applicants: Victor Racine, Talence (FR); Fanny Berard, Bordeaux (FR); François Ichas, Pessac (FR); Francesca De Giorgi, Pessac (FR)

(72) Inventors: Victor Racine, Talence (FR); Fanny Berard, Bordeaux (FR); François Ichas, Pessac (FR); Francesca De Giorgi, Pessac (FR)

(73) Assignee: FLUOFARMA, Pessac (FR)

(21) Appl. No.: 14/111,936

(22) PCT Filed: Apr. 16, 2012
(86) PCT No.: PCT/EP2012/056928

§ 371 Date: May 27, 2014

Related U.S. Application Data
(60) Provisional application No. 61/475,828, filed on Apr. 15, 2011.

(51) Int. Cl. G06T 7/20; G06K 9/62; G06F 17/30; G06K 9/46

(52) U.S. Cl. CPC G06T 7/20; G06K 9/4647; G06K 9/46; G06K 9/6267; G06F 17/30247
USPC 382/133

(57) ABSTRACT

Data processing system for generating representations and analyses of cytometric information for:—loading one set of data including:—one image of two wells on a plate each having one cell in a predetermined biological condition, each image being acquired with a microscope;—features of each cell from each image;—processing loaded data for obtaining representations and analyses of the data, from:—Histogram in one dimension;—Scattergram in two-dimensions;—Density in two-dimensions;—Plate layout management;—Cell montage;—Field;—Plate heatmap;—Dose response with regrouping of replicates;—Statistics information percentage of cell in different gates;—zFactor calculation with regrouping of replicates;—List of well for selection and list of biological condition for selection;—Statistics export capability;—Ready to print layout capability on the selected well or biological condition or all wells and biological conditions.

### FIELD OF THE INVENTION

The invention relates to cell biology imaging and/or High-Content Screening and/or high throughput screening (HTS).

### BACKGROUND OF THE INVENTION

High-Content Screening (HCS) technologies generate a massive amount of data. Today's major challenge in HCS is the analysis of those data and thus the development of effective data mining and exploration tools. Indeed images acquisition, segmentation and features extraction are now well conducted with the latest technologies such as BD Pathway™ and BD Attovision™ system. Finally, today's data analyses for biological response only provide results from a black box global analysis, overall results from each well, and do not extract the full potential from the High-Content single cell response data.

The known solutions are very complicated and demand trained people to perform accurate analysis. Several concepts of computer sciences are required (token) to achieve complete analysis.

### SUMMARY OF THE INVENTION

The present invention proposes a method, a system and a computer program allowing the visualization of cell images, the analysis and the representation of cellular data produced by microscopes and by third parties automated image processing system. It allows a user to define gates to segregate cell populations and then to quantitate assay.

In particular the invention proposes an innovative software-implemented method and system allowing the discrimination of the different cellular populations present in the well and thus individual analysis on each of them. Moreover, it also provides statistical analysis methods and eases the data management and visualization.

Thus, the invention proposes a data processing system for generating representations and analyses of cytometric information, said system being configured for:

loading at least one set of data including:
at least one image of at least two wells disposed on a plate each well having at least one cell in a pre-determined biological condition, each image being acquired with a microscope;
features of each cell extracted from each image;

processing the loaded data for obtaining representations and analyses of the data, said representations and analyses being chosen from the following;
a. Histogram view in one dimension
b. Scattergram view in two-dimensions
c. Density view in two-dimensions
d. Plate layout management
e. Cell montage view
f. Field view
g. Plate heatmap
h. Dose response with regrouping of replicates
i. Statistics information like percentage of cell in different gates
j. zFactor calculation with regrouping of replicates
k. List of well for selection and list of biological condition for selection
l. Statistics export capability
m. Ready to print layout capability on the selected well or on the selected biological condition or on all wells and on all biological conditions.

The invention can comprise at least one of the following features:
the well(s) selection and biological condition(s) selection are common for all representations.
a user input device for cell selection, the representations including highlighted information for the selected cell(s) such as surrounding data with a rectangle, overlaying a mark on a density plot and/or scatter plot)
a user input device for selecting all cells belonging to a given biological condition by single user action.
a loader for data generated by motion analysis tools such as log files exported from MDS Metamorph or NIH ImageJ software, including spreadsheet type log files, segmentation masks and original images.
a loader for data generated by motion analysis tools such as log files exported from MDS Metamorph software, including spreadsheet type log files, segmentation masks and original images.
a window auto refresh functionality for all representations when part of data is changed in one window.

The invention also proposes a method for generating representations and analyses of cytometric information performed by the system according to the invention.

The invention also proposes a user interface for use with the system of the invention, for visualizing and analyzing data from cellular image processing, comprising a graphical interface operative to designate image and statistics files source and destination, display parameters, scatter plots, heat-maps, dose responses, biological conditions input, gates in scatter-plots and histograms.

The invention also proposes a computer program executed by the system according to the invention.

The present invention aims to analyze cell biology data obtained from experiments run in a variety of format including 96- to 384-well microplate formats and provides a method and a system having the following advantages:
ergonomic: allow a fast production of result for HCS data;
versatility: can load any content of HCS (High Content Screening data) or FCS (Flow Cytometry Standard data) if export file is compatible;
automatic update of the content of all windows;
see the cell boundaries and enable visual segmentation check;

The present invention consists of an innovative software solution that can discriminate the various cell populations present in a well and thus provides individual analysis of each of them. Moreover, this solution provides statistical analysis methods and facilitates data management and display.

The invention provides a generic tool for loading and visualizing statistical data generated by cell segmentation and feature extraction. A user-friendly graphic interface displays selected features of wells of interest with various graphic options. Gates are used to identify subpopulations and to filter out unwanted cells. Cell statistics (including gate information) can be exported into table files.

An advantage of the invention is to select individual cell to check their positions in the different windows in order to place correctly the gate. Cells can be checked in galleries, in the image fields or in the scattergrams.

An advantage of the invention is to use gates to quantify high content screening data or image-based cellular assays, which is very adapted. It helps to remove all unwanted cells, and to segregate subpopulations that behave differently. It makes possible to monitor cell subpopulations using the percentage of cells in each subpopulation as a read-out. This read-out is more stable than the average of a given feature.

An advantage of the invention is to regroup easily the replicates, making the navigation inside the results very simple. In particular, it allows the direct derivation of dose response functions with error bars, and directly computes the experiment robustness measure (z factor).

Visualization of HCS data requires the display of many cellular information in separated graphs like cell view, field view, scatter plot, histogram. In the invention, all the different windows are synchronized in real time. The multiple windows allow a visual check of the position of the gates and make possible trial and error gate positioning.

The invention permits to differentiate between multiple cell populations in a given well and allows the discrimination of the different cellular populations present in the well and thus individual analysis on each of them.

The invention does not require any particular skills in computer science nor image processing or statistics knowledge for its use.

The invention also presents other multiple advantages since:
other solutions available on the market have major limitations because they are not designed for multiwell plate visualization and analysis;
other solutions on the market uses filenames to select wells which are improper due to filename complexity and because filename are not directly linked to biological conditions;
using solutions proposed on the market, it is not straightforward to compare different biological conditions or different samples or different wells;
other solutions make possible to adjust graph from different file sources which is very confusing and can lead to damageable analytical errors;
on other solutions, there is no interactivity to change the selected well, as all graphics or plots have to be connected to new well one by one;
in other solutions, the data are analyzed without segmentation error (fragments or cluster of cells) corrections or without assuming that the different cell populations present in each well have the same response to the tested compound.

### BRIEF DESCRIPTION OF THE DRAWINGS

Other features and advantages of the invention will appear in the following description. Embodiments of the invention will be described with reference to the drawings, in which:

FIG. 1 illustrates various representations obtained with the data processing system of the invention;

FIG. 2 illustrates a main window layout of the data processing system of the invention;

FIG. 3 illustrates a scattergram of the data processing system of the invention;

FIG. 4 illustrates an histogram of the data processing system of the invention;

FIG. 5 illustrates density map of the data processing system of the invention;

FIG. 6 illustrates a list of well/sample of the data processing system of the invention;

FIG. 7 illustrates a cell statistics of the data processing system of the invention;

FIG. 8 illustrates a plate layout loader of the data processing system of the invention;

FIG. 9 illustrates a heatmap representation of the data processing system;

FIG. 10 illustrates a dose response representation of the data processing system;

FIG. 11 illustrates a feature creation window of the data processing system;

FIG. 12 illustrates a feature creation using Principal Component Analysis (PCA) of the data processing system;

FIG. 13 illustrates a gate constraint of the data processing system of the invention;

FIG. 14 illustrates a cell montage window of the data processing system of the invention;

FIG. 15 illustrates a field view window of the data processing system of the invention;

FIG. 16 illustrates a Z factor window of the data processing system of the invention;

FIG. 17 illustrates a window to export statistics into a Microsoft® Excel file of the data processing system of the invention;

FIG. 18 illustrates a ready to print graph compilation of the data processing system of the invention.

### DETAILED DESCRIPTION OF THE INVENTION

### Definitions

We introduce various definitions for the understanding of the following description.

Feature: numerical value measuring a parameter in a cell. Features can reveal the cell morphology (shape quantification) or the cell intensity.

Gate: closed region in a 1D or 2D feature space. Gates are used to select cells that are present in the defined region.

Child and parent gates: a gate “C” can be linked to an existing gate “P”, such that cells inside gate “C” are inside gate “C” and gate “G.” Gate “C” is named child gate and gate “P” is named parent gate.

Scatterplot or scattergram: the data are displayed as a collection of points, each having the value of one feature determining the position on the horizontal axis and the value of the other feature determining the position on the vertical axis.

Density plot: it is calculated as a two dimensional histogram view, where the 2D space is subdivided into subunit of area. The color in each subunit of area indicates the cell count in this area. The white color indicates that no cells are detected. Other colors indicate that at least one cell is detected (black means few cells, yellow means many cells).

Well: the well is a part of a multi-well plate. Each well is treated independently form others.

Sample: If the experiment is not done on multi-well plate but in any other format, the user has to name the different samples using well name convention (A01, A02, . . . P24). Then samples are considered as wells.

Cells: referring to biological cells. By abuse of language, it can also refer to part of cells like cell membrane, nuclei, cytoplasmic compartment. Sometime the word “cell/object” will be used.

### Detailed Description of a Graphical User Interface of the Data Processing System of the Invention

### Input Data Files

Data to be opened in the data processing system are generated by third parties cell/objects segmentation software (like Metamorph™ (Molecular Device Corporation) or Attovision™ (BD Becton, Dickinson)). Those software load initial images acquired with a microscope corresponding to wells and analyze the image. It identifies the different cells/objects and segments them (meaning it defines a unique area around each cell to separate the cell from others and from the background area). The result of the segmentation is a mask for all images giving the position and the boundary of each cell/object. Then, all cells/objects are quantified by calculating morphometric parameters and/or intensity based measurements. So each cell/object is defined by a set of parameters that are called numerical features (or for sake of simplicity feature). For each well or sample corresponding to one or more channels images, an array of feature is extracted giving for each cell/object a feature set. A dataset is generally composed of a set the feature array per well. The dataset is saved into a text file or an Excel™ file.

The full dataset is composed of the original image files (one or more channels per well), the feature dataset and masks of the cell/object segmentation. The correspondence between those different kinds of information is achieved by the well names and cell indexes.

The application is for instance compatible to the following file formats:
Attovision™ statistical files (.txt). Each loaded file can contain wells from a full plate or from a fraction of it. It is only compatible with 96 and 384 multi well plates.
FCS files (.FCS version 2.0 and 3.0). The user has to load all files corresponding to a full or a part of a multi well plate. This dataset does not contain image or mask. Only features are present in the dataset.
Metamorph™ log file (.xls or .xlsx). User is asked to indicate the Excel™ file containing cellular data, then to define where the original images and segmentation masks are located. Metamorph™ log files are generated using variables logging and or application (like Neurite outgrowth).
ImageJ CSV log files. Results in ImageJ have to be exported into CSV (Comma Separated Values) files. The importation is the same as for Metamorph® log files. ImageJ is a public domain, Java-based image processing program developed at the National Institutes of Health (NIH). ImageJ was designed with an open architecture that provides extensibility via Java plugins and recordable macros.Custom acquisition, analysis and processing plugins can be developed using ImageJ's built-in editor and a Java compiler;
CytoSurfer® files.

The system loads data from the different wells composing the plate. If the features associated with the well data are not consistent along the plate then the application can reorder them and fill the missing feature with dummy values (NaN: Not a Number).

### Combining Different Files

Once a first dataset is loaded, it is possible to load a second one and bind them. There is two different ways to bind datasets. In the first case, the wells present in the first dataset are different from the wells present in the second dataset. Thus the binding consists in pooling all wells from the first dataset and from the second dataset. If some feature names from the first dataset are different from feature names of the second dataset, then a new feature name set is defined as the union of the two feature name sets. Feature data that are not reported in the datasets are assigned to NaN values.

The second way to combine two datasets is to bind two dataset referring the same well list and the same cell list but that integrate different features. In that case the two datasets are bounded by reporting for each cell the information from the two datasets.

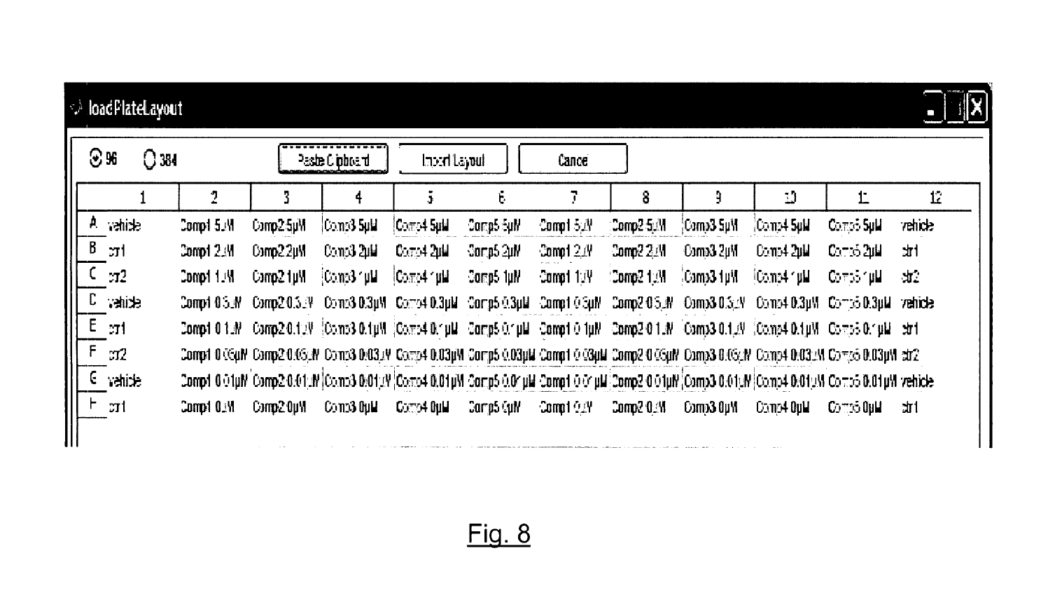

### Plate Layout Management (See FIG. 8)

Users can import the experiment's plate layout to make easier the analysis. It defines a biological condition corresponding to each well. The plate format is specified either by 96 or 384 options. User can directly change the table values or copy the data from Excel™ and press Paste Clipboard. Once the table is well filled, loading is completed by pressing the button “Import Layout”. The different wells having the same biological conditions are considered as replicates and are regrouped. The replicate grouping allows representing all cells belonging to a biological condition together in the scattergram or a histogram. It also allows computing standard deviation among replicate in order to plot error bars in dose response or computing the z factor.

With reference to FIG. 8, a window allows the user to give the correspondence between well position or sample names (A02, B05, P24 . . . ) and related biological conditions. It is represented as an editable array. Array values can be copied from Microsoft Excel™ and pasted from clipboard. Two predefined plate format are available 96 and 384. Several cells can be assigned the same biological condition and that leads to the definition of replicates.

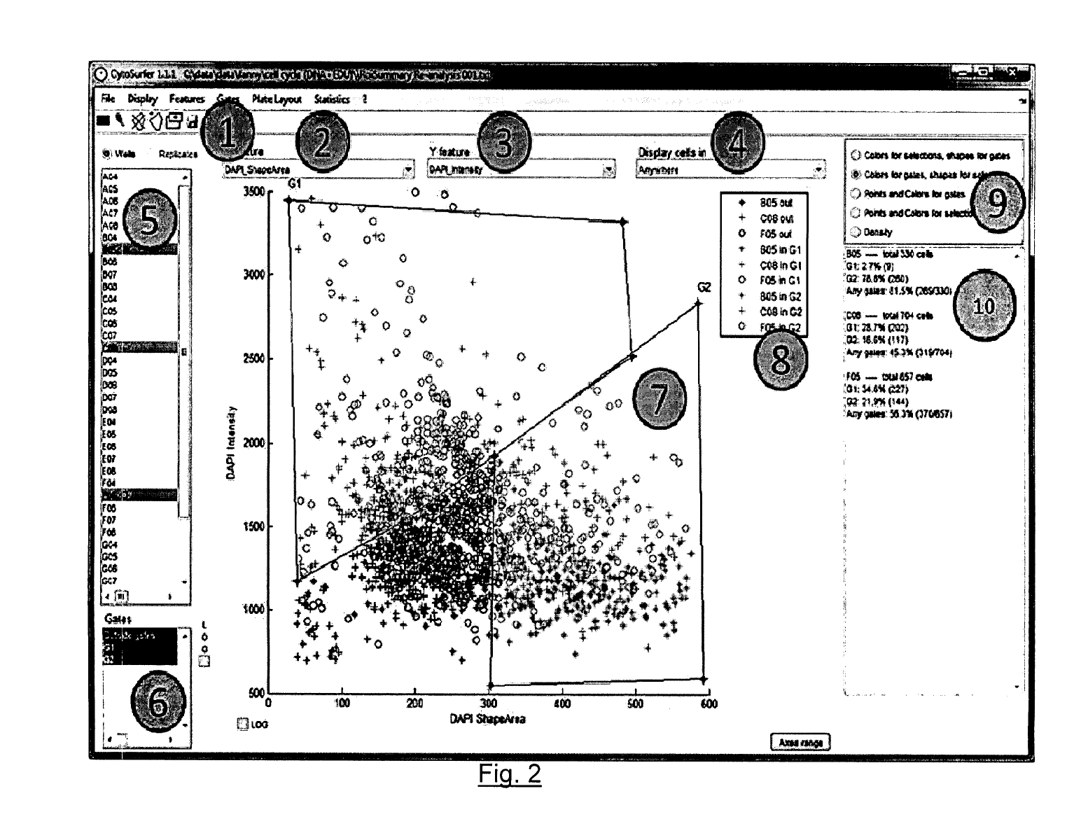

### the Main Application Layout (See FIG. 2)

With reference to FIG. 2, the application layout compiles the plate view 1, display options 4, selected features 2 and 3, the real time statistics 5, plot panel 6 and the gate management 7, the legend 8, the display option 9 and the real time statistics 10.

The plate view 1 allows selecting some wells to display. User performs a multiple selection by pressing the key Control on the keyboard and clicking on the wells. When a plate layout is loaded, the user has the choice between the well view and the replicate view. In the well view, all wells appear is the list whereas in the replicate view, biological conditions are listed and each biological condition contains several wells. In the replicate view, the different replicate names are display with under bracket the number of well corresponding to the given replicate name.

The two list boxes 2 and 3 are meant to select the features to display. If only one feature is selected, a histogram of the chosen feature is displayed. If two features are selected, a scatted plot of the two features is represented.

In the histogram view and in the scatter plot view, several display options 4 are available. First, colors encode cell gate and different symbols are used for the multi-selection. Second, colors encode multiple selection and symbols encode the gates. Third, color encode cell gate and all cells are represented by points. Fourth, colors encode multiple selection and all cells are represented by points. In all cases, the figure legend 8 gives explicitly the meaning of the different color and symbols.

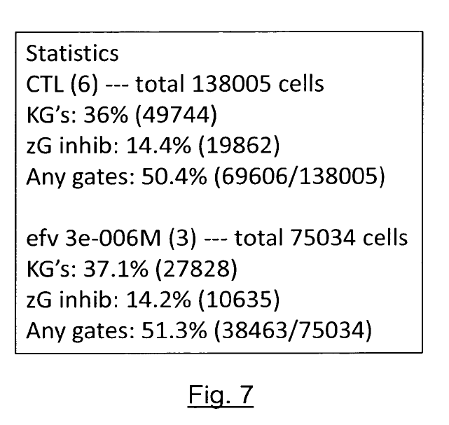

The right panel gives some real time statistics 5 on the selected wells or replicates and the gates, as shown FIG. 7. For each selected item, the name is indicated as well as the total number of cells in the selection. Then all gates are listed including gate name, percentage of cells in the gate and the cell count in the gate. Then the percentage of cells in any gates is given as well as the cell count in any gates. When the user moves a point of a gate, statistics will be constantly updated.

The plot panel 6 gives a view of the selected features and the gates. The X and Y axis names are specified on the graph. Several graphical options are usable like the log view or the density map. The plot limits can be set using several ways: first where the minimum and the maximum values are specified by the user, second the plot limits are set to the minimum and the maximum values of the current cell selection, third the plots limits are set to the minimum and the maximum values of the full dataset.

With gate management 7, different buttons allows creating, deleting and selecting gates.

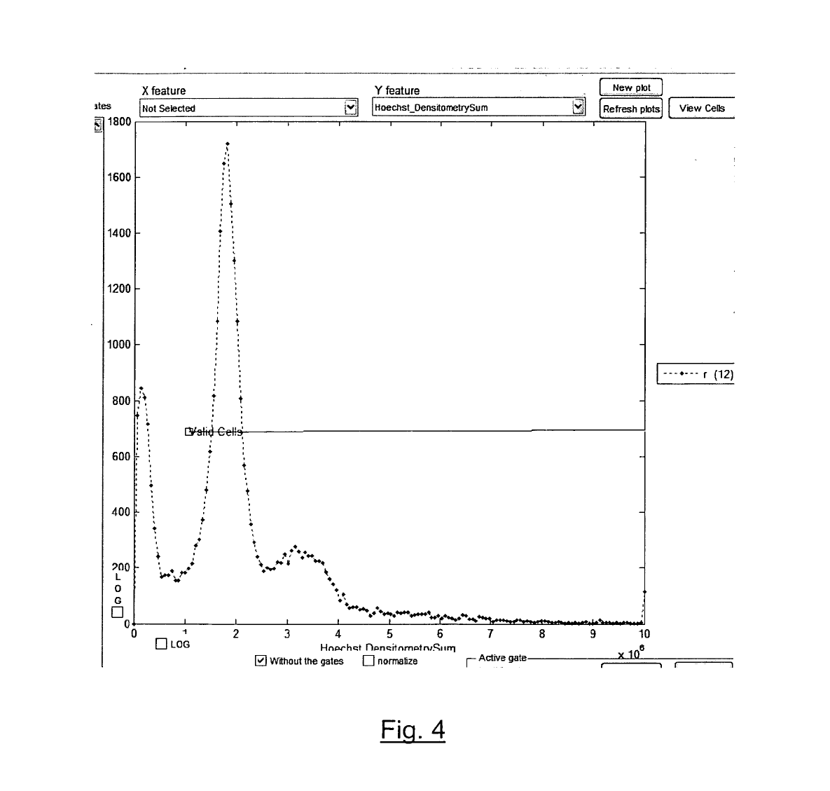

### Histogram View (see FIG. 4)

The histogram view is obtained by selecting only one feature. Each line represents one histogram and one histogram represents cells belonging to a well (or a replicate) and in a given gate. Other histograms represent for each well or replicate. The number of bins can be changed by the user. The histograms can be renormalized and expressed as ratio of the full cell population.

With reference to FIG. 4, one gate is defined.

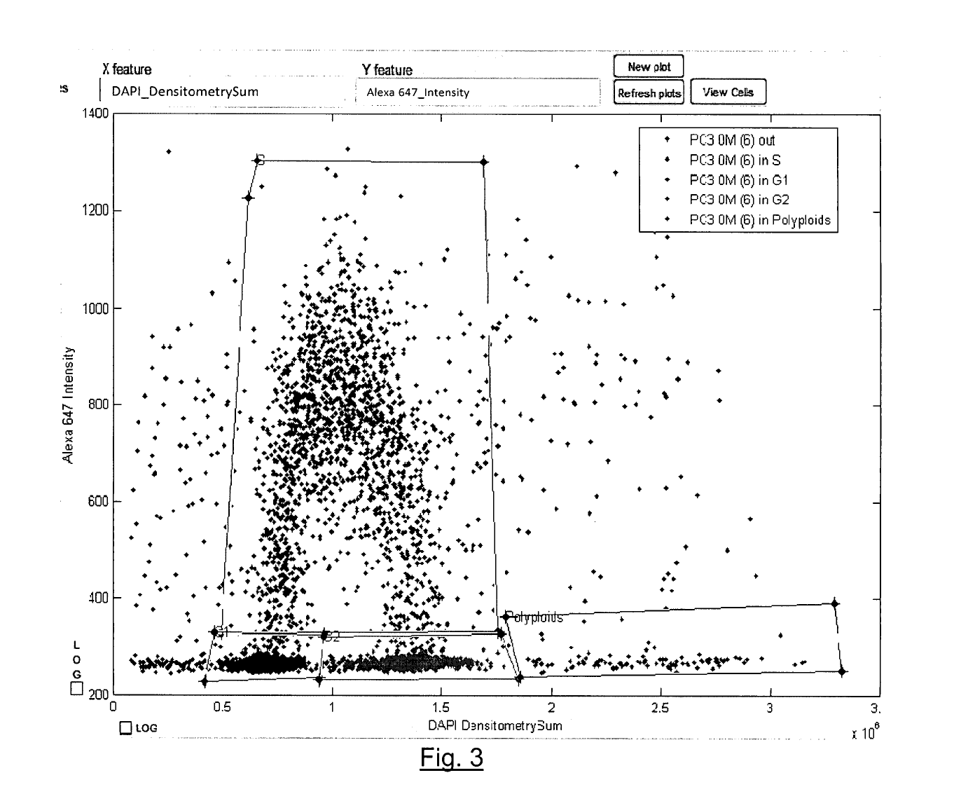

### Scatter Plot View (See FIG. 3)

To view a scatter plot, two features have to be selected. All symbols correspond to an individual cell. As for the histogram view, the axes can be either logarithmic or linear.

With reference to FIG. 3, scattergram obtained by displaying two features is shown and several gates are defined.

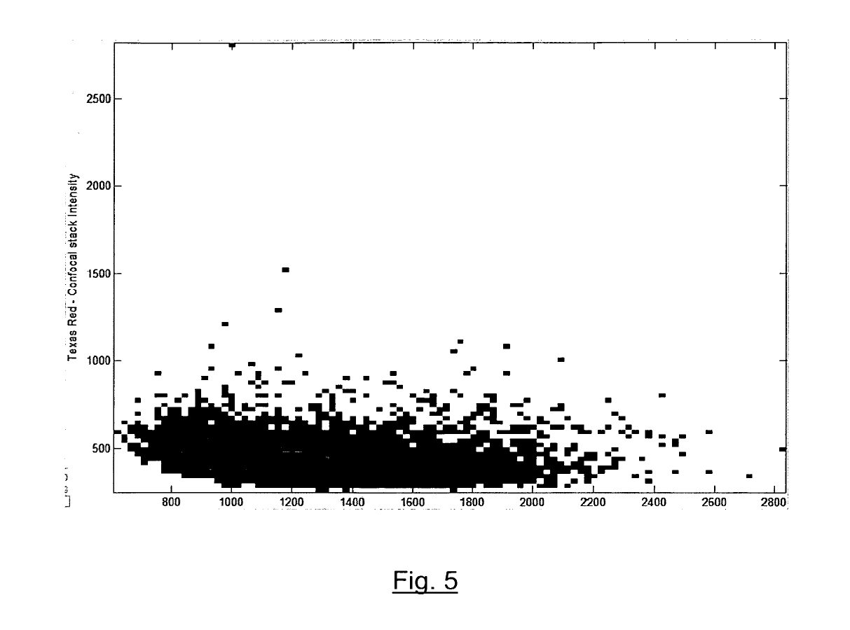

Density Map View (See FIG. 5)

Pixel intensity corresponds to the cell density. Bright pixels correspond to high-density regions. The number of bins can be set by the user.

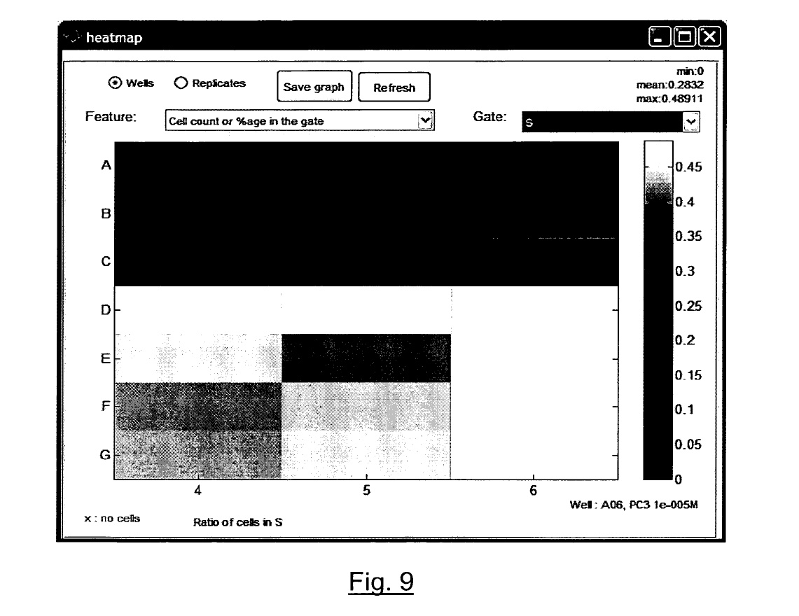

Plate Visualization Using Heatmap (See FIG. 9)

A global view of the plate is available using a heatmap representation of the 96 or 384 multi-well plate. This visualization is only accessible if the well names are formatted using the standard well names like A5, A05 or A005. This representation is a color-coding of the average intensity per well. Crosses in wells indicates that no cells are present is the well. The represented feature and the current gates can be changed using the pop-up menus. Several kind of information can be displayed:
If the feature is set to “Cell Count” and the current gate to “All cells” then the cell count per well is displayed.
If the feature is set to “percentage in the gate” and the current gate is set to one of the gates then the ratio of cell count in the gate by the cell count of the well is displayed.
If the feature is set to one the features of the data set and the current gate to “All cells” then the average of the selected feature is represented.
If the feature is set to one the features of the data set the current gate is set to one of the recorded gate then the average of the selected features of the cells included in the gate is represented. Crosses indicates that no cells are present is the gate.

If the user move or remove a gate, the heatmap representation is updated in real time.

If the user put the mouse cursor above a well in the heatmap representation, some additional information is written in the window specifying the well label (like A05), the biological condition if it is referenced and the current value according the heatmap parameters.

With reference to FIG. 9, the representation is an intensity color-coding of the plate by displaying a feature average (or median value) potentially constrained to a gate per well. The correspondence between colors and numbers are obtained by looking at the color bar on the right side of the windows.

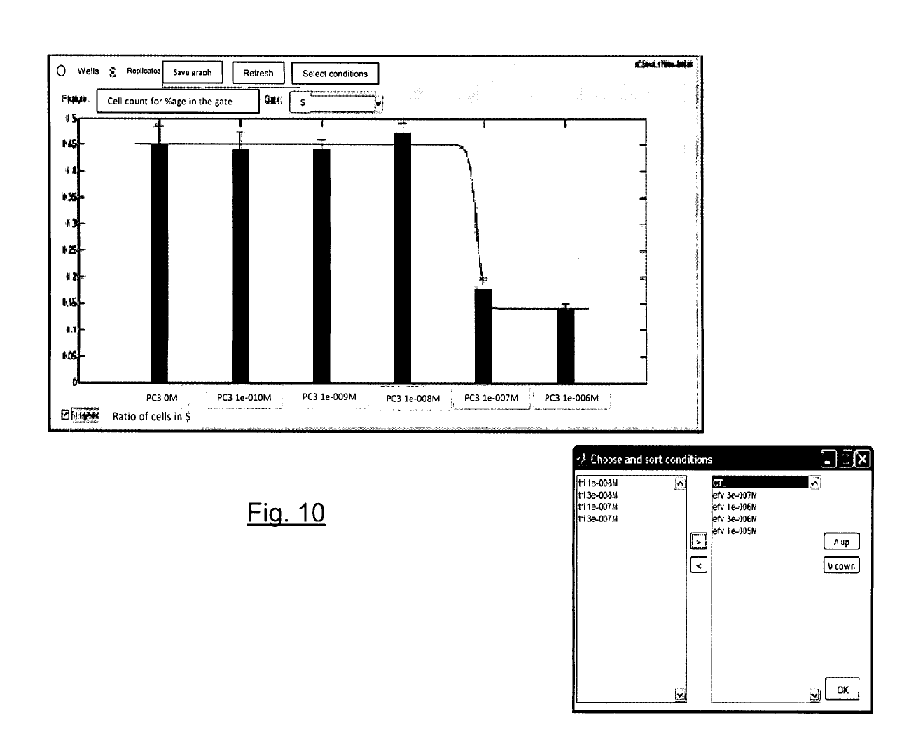

### Dose Response Visualization (See FIG. 10)

A dedicated window allows visualizing dose response. The user can select biological conditions (FIG. 10 right) to generate a bar plot with error bars with only the selected biological conditions. The bar intensity is the average of the individual replicates and error bar is the standard deviation among the replicates. The interface allows to perform a sigmoid curve fitting and to calculate the IC50 (for decreasing curve) of the EC50 (for increasing curve). The curve fitting is achieved using a non linear regression, for example with the Maltab™ function (nlinfit). This window is updated in real time, such as, if the user moves a gate, the bars and the errors bars are automatically updated.

With reference to FIG. 10, a selection of biological conditions is plotted in the left window. The feature to plot is chosen by the user as well as a gate. Each bar of the bar plot correspond to the average of well average for each biological condition for the chosen condition. The error bar is measured as the standard deviation among replicates. If it is relevant, the bars can be fitted to a sigmoid curve and the IC50 (for inhibitory concentration) or EC50 (for effective concentration) are expressed whenever the curve fitting is accurate. The selection of biological conditions is achieved using the right window that allows a reordering of the biological condition is necessary.

### Gate Management (see FIGS. 2 to 7)

Gates are used to select cells according to their localization. Each gate is associated to one or two features. The gate is drawn in the associated features. If the gate is drawn in the histogram view, then the gate is associated to one feature. If the gate is drawn in a scatter plot then the gate is associated to two features. In the scatter plot view, the user is meant to draw a closed polygon on the graph. In the histogram view, the user has to draw a line to define the selection interval of the gate. A new gate can be linked to another by selecting an already defined gate in proposed list (“Base the new gate on”). If the choice is “new gate” then the new gate will be independent to all other gates. But if the choice is an existing gate then the resulting gate will be the intersection between the new gate and the selected gate.

The process can be extended to any gate number. When a gate is linked to another, the two gates can be defined in the same feature set or not. If the button delete gate is pressed the gate selected in the list box is deleted. All gates can be moved either by moving 1 point of the polygon or by drifting the full gate. The symbol and the color of the cells are not automatically refreshed when a gate is changed.

The gate list can be exported and imported another time using text files. It is also possible to remove points inside a gate or outside a gate. This is generally used to remove unwanted cell population like error of segmentation or cell clusters. Cell removal is applied to the full dataset (to all wells).

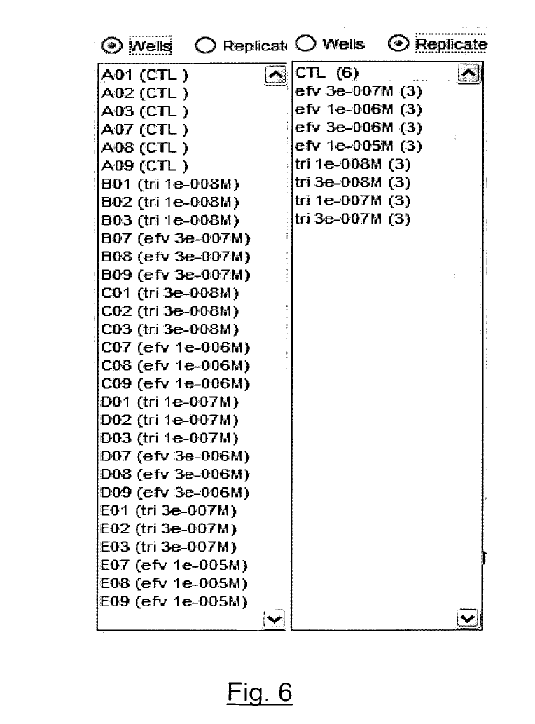

With reference to FIG. 6, a representation of the well/sample list is shown (left panel). Each well name is juxtaposed with the corresponding biological condition under brackets. On the right, representation of the biological conditions and under brackets the number of well/sample corresponding to the biological condition. The user can select one or more wells or biological conditions in order to compare them

With reference to FIG. 7, cell statistics about current well or biological condition selection are shown (see FIG. 5). For each selected item, the name is indicated as well as the total number of cells in the selection. Then all gates are listed including gate name, percentage of cells in the gate and the cell count in the gate. Then the percentage of cells in any gates is given as well as the cell count in any gates.

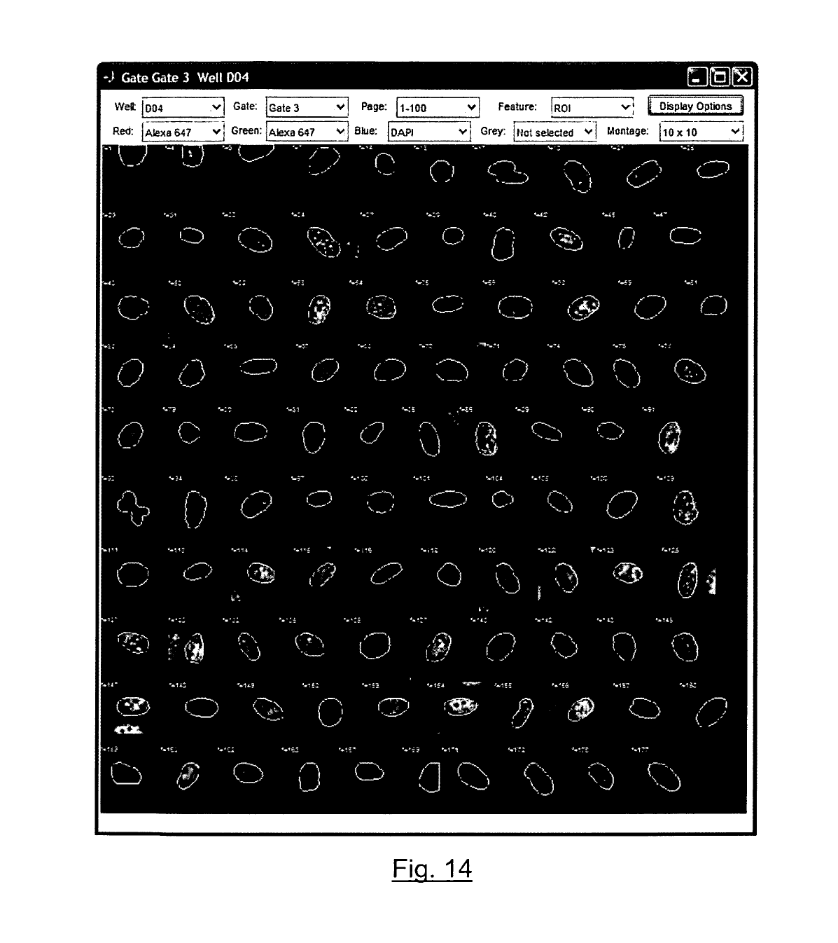

### Cell Montage Viewer (See FIG. 14)

A button View cells allows viewing some cells in a given gate. This feature is only available if the dataset contains links to valid image files. The user has to choose a gate in which the cells will be picked and a particular well. To ease the process, only wells contained in the current selection are proposed as choice to the user. Thus, a figure is created showing a montage of cropped cells. On each cell a feature value is added to get a direct understanding of feature values. In the new figure many display options are available. First, the selected well is indicated and can be changed. Second, the cell montage can be obtained using overlay of different channels. Each channel can be attributed to one of those colors: green red blue and grey. The cyan line corresponds to the contour of the cell of interest whereas the blue ones correspond to the surrounding cells. Third, the chosen gate is indicated and can be changed. Fourth, the montage parameter indicates the number of cells in the montage: 3×3, 5×5 or 10×10. If all the cells cannot fit into the montage, several pages are accessible. Fifth, the user can change the page, if several pages are accessible. Sixth, the feature displayed on each cell can be changed.

With reference to FIG. 14, a cell montage window is shown. It represents a list of many cells contained in a given well (D04 in the current example) and in the gate “Gate 3”. For each channel image, the user can choose what the color to represent it is. The montage is composed of numbers of cells cropped from the initial images and reassemble to form a montage. The cell segmentation boundaries are represented by a line surrounding cells. User can choose a cell feature to be displayed in the cell corner (in the example the ROI index feature is displayed).

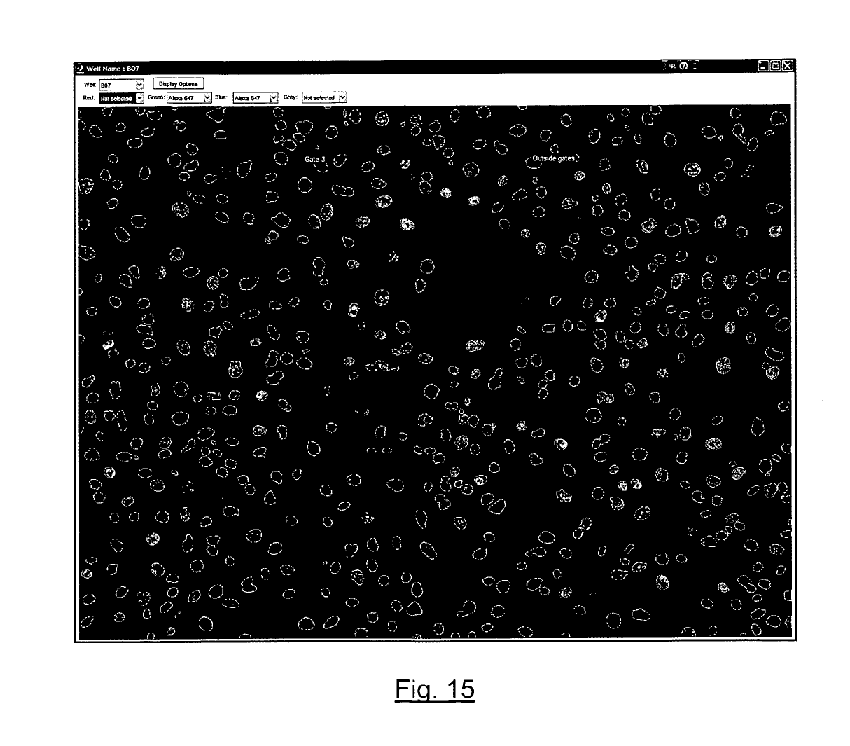

### Field View (see FIG. 15)

The field view is obtained by clicking into a well in the heatmap representation. It opens a window containing an overlay of the different channel of the selected well. The overlay is controlled by the same options than in the cell montage. A color is given for all cells outside of any gate. The correspondence between colors and gates is given directly in the field image. The user can click on a cell and view its position in the scatter plots and in the cell montage if this cell is present in the montage. The color of the cell contour is given by the gate containing the cell.

With reference to FIG. 15, a field view window is shown. The original field images are displayed as channel overlay if necessary. The cell boundaries appear in different color depending in which gate they are.

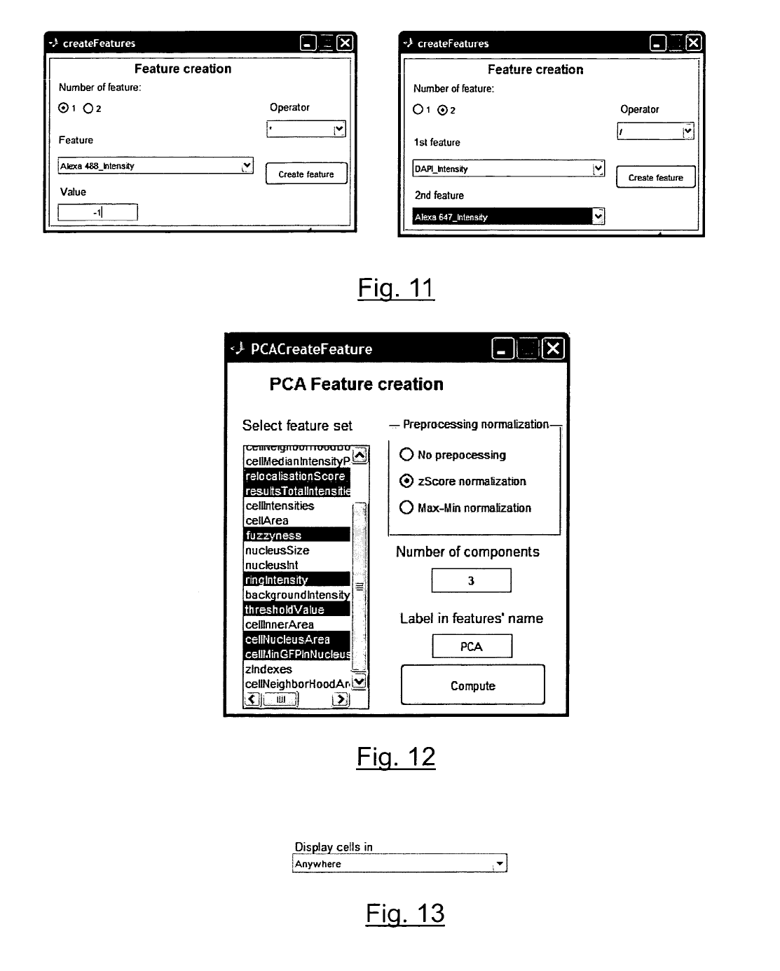

### Creation of New Features (See FIG. 11)

In many situations, creating new features from the existing ones is valuable. Two ways of creating feature is possible, either combining two features (like multiplying 2 features) or combining one feature and a fixed value (like dividing one feature by 1000). A dedicated interface allows performing those operations. The number of features has to be set and the subsequent features have to be selected like in the following examples. For each feature creation an operator is selected among the usual operator *, /, +, −.

With reference to FIG. 11, feature creation windows are shown. The two windows allow the user to create some new features by combining the existing ones using arithmetic operators. Either one existing feature (left figure) or two features (right figure) are used. If one feature is used the existing feature is combined with a fixed value indicated by the used. The proposed arithmetic operators are addition, subtraction, multiplication and division.

### Creation of New Features Using PCA (See FIG. 12)

A dedicated interface allows computing the first principle component of a dataset. The user is required to select features from the current dataset on which a PCA is applied. The user has to select the number of components to be added in the current dataset, as well as a preliminary normalization. The available normalizations are non-normalization, “z score” normalization and “min max” normalizations. The “z score” normalization can be achieved using zscore Matlab™ command. The “min max” normalization stretches (affine transformation) the dataset such as the new minimum is 0 and the new maximum is 1.

With reference to FIG. 12, feature creation using PCA analysis are shown. This window allows choosing some features, potentially renormalizing the features and applying PCA analysis. User chooses the number of principal component to keep and those component are considered as new features.

### Feature Deletion

In order to lighten the data and to increase the readability, some features can be deleted for a better focus on the important ones. This can be done by selecting one or several features to delete. If a selected feature is used by a gate then the given feature is not deleted.

### Export Statistics (see FIG. 17)

Once the gates are correctly placed, an export function generates the statistics of the dataset. Those statistics give a quantitative summary of each well and each replicate. The user can choose the type of statistics to be performed on the dataset. The available choices are:
mean of cells per well,
median of cells per well,
standard Deviation (STD) of cells per well,
mean of well means (where wells means are means of cells per well),
mean of well medians (when well medians are medians of cells per well),
STD of well means (where wells means are means of cells per well),
STD of well medians (when well medians are medians of cells per well).

The user can also choose the gates in which the statistics will be calculated. One the options are set by the user, the statistics are exported into an excel file.

With reference to FIG. 17, a window to export statistics into a Microsoft Excel™ file is shown. The user has to choose to the features as well as the gate to export. The user has to choose the types of statistics to export in the file. Each type of statistics is computed for all cells and in the selected gates.

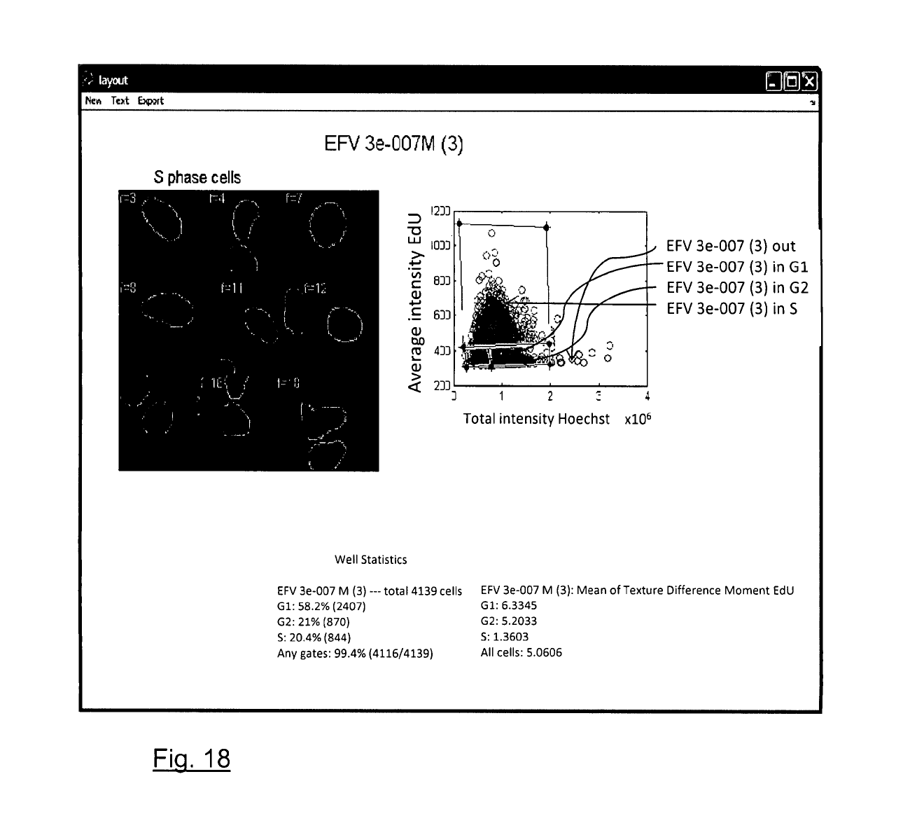

### Ready to Print Graph Compilation (See FIG. 18)

In this document layout, the user places and arranges any graphs of the application. It can be scattergrams, histograms and cell montage as well as some textual information like the current well or biological condition and statistics. All information present in this graph is related the current well or biological condition selection.

With reference to FIG. 18, a ready to print graph compilation is shown. In this document layout, the user places and arranges any graphs of the application. It can be scattergrams, histograms and cell montage as well as some textual information like the current well or biological condition and statistics. All information present in this graph is related to the current well or biological condition selection.

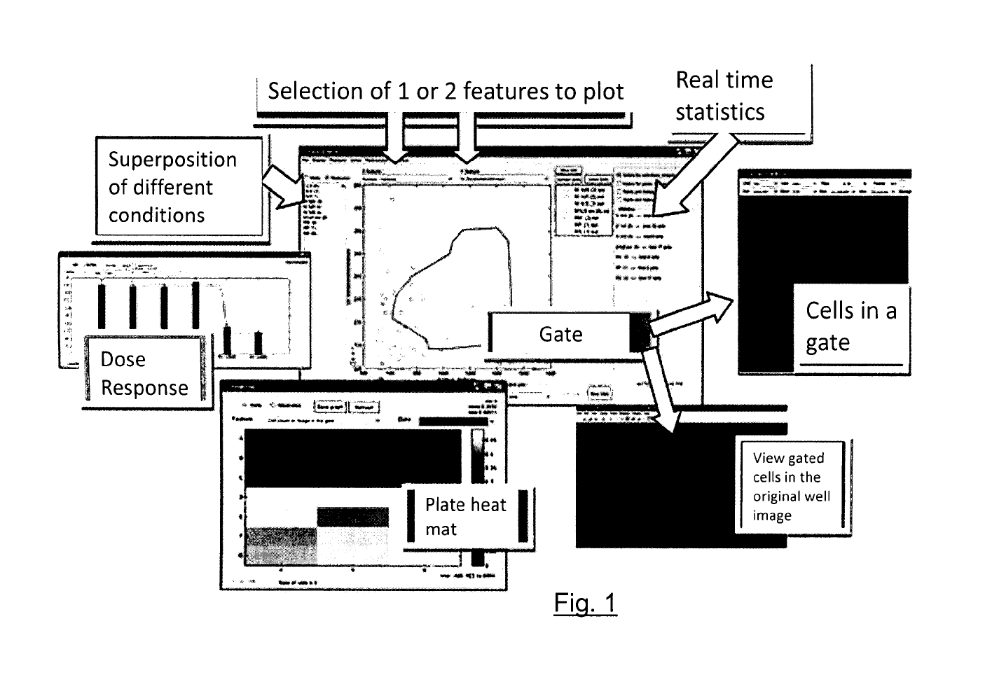

### Automatic Updating (see FIG. 1)

All windows are connections through event processing. Whenever a gate is moved or removed, all the windows are automatically updated such as the user can directly monitor the impact the gate transform.

With reference to FIG. 1, main figure of the present invention is shown. All views are different representation of the same information. It gives simultaneously inside single software, access to morphologic information, statistics, plate heat-map, IC50, cell montage, field view, etc. It allows improving gate placement using trial and error strategy.

### Cell Selection

It is possible that the user clicks on a given cell either on scattergrams, or on density maps, or on cell montages or on field views. The selected cell is represented by a red cross on the scattergram and density maps or surrounded by a red rectangle in field views and cell montages. This enables the monitoring of a same cell on the different views. It eases the correct positioning of the gate using trial and error strategy.

### Example

A cell cycle study related example is now described.

The dataset used for the case study is a 96 well plate with Hoechst (nuclei staining) and EdU-GFP (DNA synthesis). The dataset is acquired using the BD Pathway™ 855.

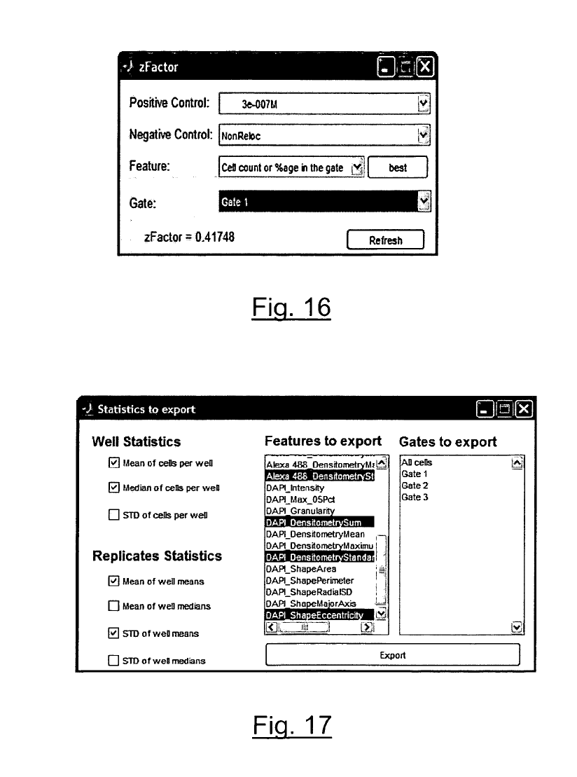

1. Open Attovision™ statistical file (click on open Attovision™ statistical file).
2. Load a plate layout (click on Load plate layout) and paste biological condition from excel (press copy from clipboard button, see FIG. 8). The plate layout contains a dose response of camptothecin in quadruplicates and several control wells.
3. Remove unwanted cell (like cell fragments and cell doublets):
a. Select in the biological condition list view (FIG. 6) the control condition.
b. Draw a scattergram: select as the first feature DNA content (total intensity in Hoechst channel, see FIG. 2 selected feature 2) and as the second nucleus perimeter (see FIG. 2, selected feature 3)
c. Draw a gate to select cell doublets: DNA content is high and perimeter is high also (see FIG. 3).
d. To check the correct position of the gate, open a view cell montage window. With reference to FIG. 13, gate constraint is shown. The list box “Display cells in” defines the gate constraint. If a gate is selected, only cells in this gate are displayed in the scatter plot and in the histogram. The real time statistics 10 are subject to the gate constraint.
e. Adjust the gate position by looking at the cell montage in the gate.
f. Remove cells in the gate.
g. Draw a histogram (see FIG. 4) using the feature nucleus area.
h. Draw a gate to select cell fragments: DNA content is small and perimeter is small also (see FIG. 3).
i. Remove cells in the gate.
   4. Cell cycle study
a. Draw a density map (see FIG. 5): select as the first feature DNA content (total intensity in Hoechst channel, see FIG. 2, selected feature 2) and as the second EdU intensity (see FIG. 2, selected feature 3)
b. Draw gates to select cell cycles (subG1, G1, G2, S) like plotted gates in the FIG. 3.
c. Check the position of the cell in the gates in the field view window (see FIG. 15).
   5. Quality control using the heatmap window (see FIG. 9).
a. Choose each gate one by one and check if some wells have outlier values.
b. If a well has a suspect value the user clicks on the well to open a field view window and understand the reason why this value is so different from other.
c. If a well has encounter a problem and the user wants to remove it from the dataset, the user open the plate layout and change the value of the well to “to remove”. Thus the selected well will not be considered as part of the dataset any more.
   6. Draw the curve response (see FIG. 10).
a. Select the doses to plot in the graph and reorder then if necessary.
b. Choose a gate in which the cell percentages are represented.
c. The user can visualize the variability among replicates with error bars that correspond to standard deviation.
d. The user can change the position of the gates and monitor the effect on the dose response curve and its error bars.
e. Fit the bars with a sigmoid curve and read the IC50.
   7. Compute the zFactor.
a. Open the zFactor window. With reference with FIG. 16 Z factor (or Z′) is shown. This factor allows measuring the robustness of the assay. The user chooses two biological conditions that are considered as positive and negative control. Furthermore a feature is chosen and potentially a gate. The z factor is given automatically. This window is synchronized with others if a gate is moved then the z factor is updated instantaneously.
b. Select a gate to measure inside the cell percentages.
c. Select as negative control, the plate control and as positive control a dose of camptothecin.
d. Validate the zFactor value.
   8. Export statistics to an Excel™ file.
a. Open the export statistics window (see FIG. 17).
b. Select “Mean of cells per well”, “mean of well means” and “std of well means”.
c. Export.
   9. Design a ready to print graph compilation (see FIG. 18).
a. Include all graphs that are important for the understanding of the experiment.
b. Include statistics and textual information.
c. Export the current layout for all wells and all biological conditions.

Comparison Between the Invention and Other Products Known in the Art

The table below summarizes the differences between the invention and the known solutions of the prior art.

| | | | iCys | |
|---|---|---|---|---|
| | | | Standard | |
| | | | Cytometric | |
| | The | FCS Express | Analysis | Cell profiler |
| Characteristic | invention | 4 Image | Software | analyst |
| Use of gates to | Yes | Yes | Yes | No. Only to |
| segregate cell | | | | create a cell |
| population | | | | montage |
| Plate | Fully | Very partially. | Yes | Very partially. |
| visualization | dedicated to | Only heatmap | | Only heatmap |
| | plate | representation. | | representation. |
| | visualization | | | |
| Grouping | Yes. Using | No | No | No |
| replicates | Import plate | | | |
| | layout | | | |
| Drawing dose | Yes with | Yes without | No | No |
| response | error bars | error bars, | | |
| | and EC50 | and no EC50 | | |
| | calculation | calculation | | |
| zFactor | Yes using a | Need to | No | No |
| measurement | dedicated | define several | | |
| | window | tokens to | | |
| | | obtain it. | | |
| Draw graph | Yes. Click to | Yes. User | Yes | No |
| form a first | the second | has to | | |
| well and then | well. All | change the | | |
| jump to | plots will be | source file of | | |
| second well | updated | each plot, | | |
| | automatically | field view. It is | | |
| | | not automatic | | |
| Superimposition | Yes. Using | No | Partially. | No |
| of different | an unique | | User can | |
| wells or | color coding | | select | |
| different | per well or | | several | |
| biological | per | | wells but all | |
| conditions | biological | | cells from | |
| | condition | | the | |
| | | | selected | |
| | | | wells are | |
| | | | pooled | |
| | | | together | |
| | | | without | |
| | | | color | |
| | | | coding | |
| Place a gate | Yes. For | Yes. First, | Yes | No |
| linked to | any gate | open the | | |
| another gate | creation, the | main menu, | | |
| | user is | click on edit | | |
| | asked to | preference, | | |
| | create a | choose the | | |
| | gate not | gate | | |
| | linked to | preference | | |
| | another or | tab, turn on | | |
| | to select an | the “create it | | |
| | existing | hierarchically” | | |
| | gate in the | option and | | |
| | proposed | create a new | | |
| | list of the | gate. The | | |
| | window | new gate will | | |
| | | become a | | |
| | | child of the | | |
| | | plot's current | | |
| | | gate. You | | |
| | | cannot select | | |
| | | a specify gate | | |
| | | to be linked. | | |
| Automatic | Yes. Full | Yes, for gate | Yes | No |
| update | capability | move, but not | | |
| | | when user | | |
| | | changes data | | |
| | | sources | | |
| Cell galleries | Yes. | Partially. | Yes | Yes |
| | Capability to | View each | | |
| | view cell | channel | | |
| | segmentation | independently | | |
| | and | of cropped | | |
| | display any | cells with | | |
| | channel | poor | | |
| | overlay with | resolution | | |
| | full | and no | | |
| | resolution | overlay. | | |
| Export | Yes. Full | Partially. It | Partially. It | Partially. It |
| Statistics | capability. | gives the | gives the | gives the |
| | Use Export | statistics per | statistics | statistics per |
| | Statistics | well only. | per well | well only. |
| | window. It | | only. The | |
| | gives the | | statistics | |
| | statistics per | | are not | |
| | well, and, | | given in | |
| | the replicate | | percentage | |
| | standard | | | |
| | deviation | | | |
| | and | | | |
| | averages | | | |
| Field view with | Yes. Full | Partially. No | Yes | No. The field |
| gate | capability. | image | | view is |
| | Overlay of | overlay. Filled | | possible but |
| | any | region of | | the gates are |
| | channels | segmentation | | not |
| | and border | and color | | represented |
| | segmentation | coding for | | in this view |
| | and color | gates. | | |
| | coding for | | | |
| | gates | | | |
| Complexity | Simple | Very | Simple | Intermediate |
| | | complicated | | complexity |
| | | and require | | |
| | | dedicated | | |
| | | training and | | |
| | | skills to | | |
| | | program | | |
| | | tokens | | |
| Scale image | Yes | No | No | No |
| intensities for | | | | |
| visualization | | | | |
| Click on single | Yes. | No | Partially | No |
| cell | 1/User can | | User can | |
| | click on a | | click on the | |
| | scattergram | | cell in the | |
| | cell and see | | field view | |
| | the cell in | | and see | |
| | this cell | | this cell in | |
| | montage | | the | |
| | and in the | | scattergram. | |
| | field view. | | User can | |
| | 2/The user | | click on the | |
| | can click on | | scattergram | |
| | a cell in the | | and see | |
| | cell | | this cell in | |
| | montage | | the field | |
| | and see this | | view. | |
| | cell in the | | | |
| | scatter gram | | | |
| | and in the | | | |
| | field view. | | | |
| | The user | | | |
| | can click on | | | |
| | the field | | | |
| | view and | | | |
| | see the cell | | | |
| | in the | | | |
| | scattergram | | | |
| | and in the | | | |
| | cell | | | |
| | montage. | | | |
| Software | No | No | Yes | No |
| dedicated to an | | | | |
| acquisition | | | | |
| platform | | | | |
| Create features | Yes. Using | Yes. But | Yes. | No |
| | the window | using token | Partially. | |
| | create | programming | The ratio | |
| | feature | | between 2 | |
| | | | existing | |
| | | | features | |
| | | | cannot be | |
| | | | computed | |

1. Data processing system for generating representations and analyses of cytometric information, said system being configured for:
loading at least one set of data including:
at least one image of at least two wells disposed on a plate each well having at least one cell in a pre-determined biological condition, each image being acquired with a microscope;
features of each cell extracted from each image;
processing the loaded data for obtaining representations and analyses of the data, said representations and analyses being chosen from the following:
a. Histogram view in one dimension
b. Scattergram view in two-dimensions
c. Density view in two-dimensions
d. Plate layout management
e. Cell montage view
f. Field view
g. Plate heatmap
h. Dose response with regrouping of replicates
i. Statistics information like percentage of cell in different gates
j. zFactor calculation with regrouping of replicates
k. List of well for selection and list of biological condition for selection
l. Statistics export capability
m. Ready to print layout capability on the selected well or on the selected biological condition or on all wells and on all biological conditions.

2. The system of claim 1, wherein the well(s) selection and biological condition(s) selection are common for all representations.

3. The system of claim 1, comprising a user input device for cell selection, the representations including highlighted information for the selected cell(s) such as surrounding data with a rectangle, overlaying a mark on a density plot and/or scatter plot)

4. The system of claim 1, comprising a user input device for selecting all cells belonging to a given biological condition by single user action.

5. The system of claim 1, comprising a loader for data files generated by bio imager data management tools such as BD Biosciences AttoVision Software, including statistics files, segmentation files (.ROI) and original images.

6. The system of claim 1, comprising a loader for data generated by motion analysis tools such as log files exported from MDS Metamorph or NIH ImageJ software, including spreadsheet type log files, segmentation masks and original images.

7. The system of claim 1, comprising a window auto refresh functionality for all representations when part of data is changed in one window.

8. A method for generating representations and analyses of cytometric information performed by the system according to claim 1.

9. A user interface for use with the system of claim 1, for visualizing and analyzing data from cellular image processing, comprising a graphical interface operative to designate image and statistics files source and destination, display parameters, scatter plots, heat-maps, dose responses, biological conditions input, gates in scatter-plots and histograms.

10. A computer program executed by the system according to claim 1.
